(19) United States
(12) Patent Application Publication
(10) Pub. No.: US 2005/0106539 A1
(43) Pub. Date: May 19, 2005

(54) Self-configuring keyword derivation

(75) Inventors: Elizabeth V. Bagley, Cedar Park, TX (US); Pamela A. Nesbitt, Tampa, FL (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/714,690

(22) Filed: Nov. 17, 2003

(51) Int. Cl. G09B 5/00

(52) U.S. Cl. 434/169

(57) ABSTRACT

A keyword generation system, method and apparatus. The method of the invention can include the steps of locating words and phrases in a selected portion of content, where the words and phrases are specific to a particular domain. The method also can include the step of adding a single instance of each of the located words and phrases to a list of keyword candidates. For each located word and phrase which already had been added to the list of keyword candidates, a counter associated with the located word and phrase can be incremented. Consequently, keywords from the list of keyword candidates can be selected based upon words and phrases in the list having a highest counter value.

### BACKGROUND OF THE INVENTION

1. Statement of the Technical Field

The present invention relates to the content management and more particularly to the definition of keyword metadata for learning content.

2. Description of the Related Art

Learning management systems provide for the total management of an on-line learning experience—from content creation to course delivery. In the prototypical learning management system, one or more course offerings can be distributed about a computer communications network for delivery to students enrolled in one or more corresponding courses. The course offerings can include content which ranges from mere text-based instructional materials to full-blown interactive, live classroom settings hosted entirely through the computer communications network. So advanced to date has the ability of learning management systems to deliver content become, that nearly any learning experience formerly delivered through in-person instruction now can be delivered entirely on-line and even globally over the Internet.

The conventional learning management system can include a learning content management server configured to manage the introduction and distribution of course materials to enrolled students. The learning management server further can be configured to import course content created both by coupled authoring tools and third party authoring tools which can package course content according to any one of the well known course content packaging standards, such as the ADL Shareable Content Object Reference Model (SCORM), the IEEE Learning Object Model (LOM) and the Aviation Computer Based Training Committee (AICC) standard. Once imported, online course instances can be created based upon a course master reflecting the packaged course content. The on-line course instances can be cataloged for public availability to registered students and the content reflected within the on-line course instances can be distributed to the students on-demand.

Keywords are optional metadata components described within the SCORM and LOM standards. Historically, content development products provided a graphical user interface through which content developers can manually enter keywords to be associated with the content. This manual effort can be intensive and inherently can reduce an immediate return on a learning content management system implementation. In contrast, conventional learning content management system implementations have begun to focus upon drawing new or existing content into the repository.

As the e-learning shifts to a blended approach of knowledge content management and learning content management, legacy knowledge content of various formats will also need to be added to any learning content management system implementation. Yet, despite the new focus of conventional learning content management system implementations, conventional learning content management system implementations do not provide a mechanism for automating the importation of legacy content. More importantly, conventional learning content management system implementations do not automate the derivation of metadata including keywords for the legacy content. Thus, specifying metadata for legacy content, and in particular—keywords—remains a manually intensive effort.

### SUMMARY OF THE INVENTION

The present invention addresses the deficiencies of the art in respect to producing metadata for legacy content in a learning content management system and provides a novel and non-obvious method, system and apparatus for self-configuring keyword derivation for learning content. In accordance with the present invention, In a preferred aspect of the present invention, a keyword generation system can include a content parser configured to parse individual words and phrases in a selected portion of content, a dictionary of words and phrases specific to a particular domain associated with the content, a list of keyword candidates comprising a plurality of words and phrases specific to the particular domain, and a counter for each of the words and phrases in the list.

A keyword generation process can be coupled to each of the content parser, the dictionary, the list, and the counter. Also, the keyword generation process can be programmed to identify the words and phrases specific to the particular domain in the selected portion of content and to write the identified words and phrases to the list of keyword candidates. The keyword generation process further can be programmed to increment the counter for each of the words and phrases in the list each time the keyword generation process locates each of the words and phrases in the selected portion of content. Finally, the keyword generation process can be programmed to select one or more of the words and phrases in the list as keywords for the content based upon the counter for each of the words and phrases in the list.

A keyword generation method can include the steps of locating words and phrases in a selected portion of content, where the words and phrases are specific to a particular domain. The method also can include the step of adding a single instance of each of the located words and phrases to a list of keyword candidates. For each located word and phrase which already had been added to the list of keyword candidates, a counter associated with the located word and phrase can be incremented. Consequently, keywords from the list of keyword candidates can be selected based upon words and phrases in the list having a highest counter value.

Notably, in a preferred aspect of the invention, words and phrases in the content which have been visually rendered so as to emphasize the words and phrases are treated as inherent indications by the author that the words and phrases ought to be considered as keywords. To that end, the method further can include the steps of detecting a variation in font attributes in the selected portion of content, selecting a string in the selected portion of content affected by the variation, and, adding the string to the list of keyword candidates. Moreover, in a self-configuring fashion, the sting can be considered subsequently as yet another word and phrase which is specific to the particular domain.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is block diagram illustrating a system for self-configuring keyword derivation for learning content; and,

FIGS. 2A and 2B, taken together, are a flow chart illustrating a process for self-configuring keyword derivation for learning content.

### DETAILED DESCRIPTION OF THE PREFERRED EMBODIMENTS

The present invention is a system, method and apparatus for deriving a set of keywords from learning content in a learning content management system. In accordance with the present invention, learning content can be parsed to identify individual words and phrases. Specific known words and phrases can be identified within the learning content and added to a list of possible keywords. Moreover, a counter can be incremented for each identified word or phrase. Importantly, words and phrases having font attributes which vary from the font attributes of the other words in the content can be added to the list of possible keywords. Additionally, a counter can be incremented for those words and phrases as well. Finally, those words and phrases having varying font attributes can be added to the set of specific known words and phrases for use in subsequent analyses.

Once all of the content has been processed to identify within the content the specific words and phrases and those words and phrases which have varying font attributes, a selection of the words and phrases in the list of possible keywords can be chosen as the keywords for the content. In particular, the words and phrases can be chosen based upon the value of their respective counters. Those words and phrases in the list of possible keywords having counters which have higher values can be chosen, while those words and phrases in the list of possible keywords having counters which have lower values can be discarded. In this way, legacy content can be added to the learning content management system and keywords can be derived there from automatically without requiring manual intervention.

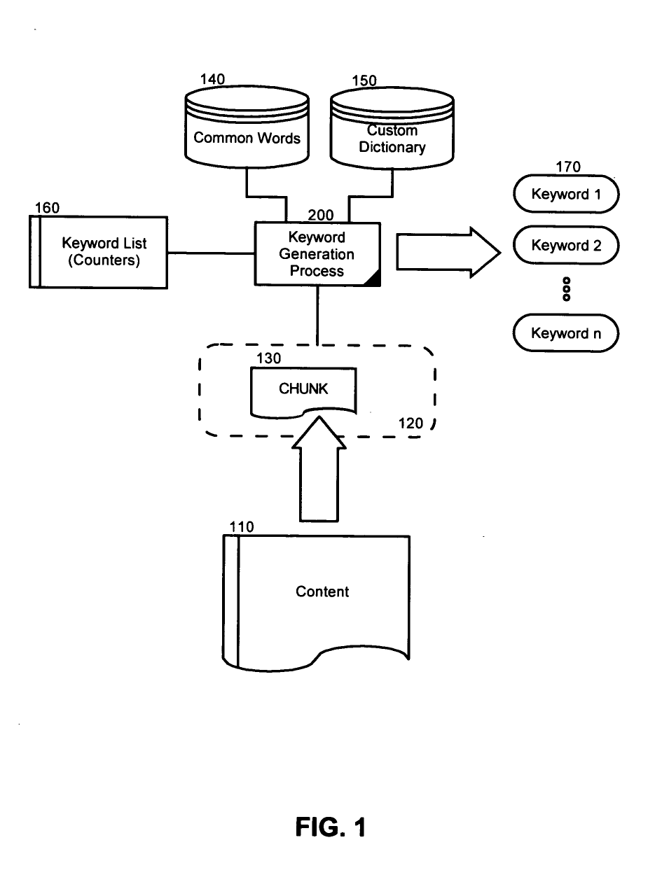

FIG. 1 is block diagram illustrating a system for self-configuring keyword derivation for learning content. The system can include a keyword generation process 200 coupled to each of a data store of common words 140 and a dictionary of specific words and phrases 150. The data store of common words 140 can include a selection of words known in a particular language. The selection can be configurable based upon a threshold number of words, such as five-hundred (500), for instance. The dictionary of specific words and phrases 150, by comparison, can include a listing of words and phrases specific to a particular domain. Specifically, the listing of specific words and phrases 140 can include words and phrases which are notable and important to the domain to which particular content relates.

The keyword generation process 200 can be programmed to process content 110 to identify a selection of keywords 170 associated with the content 110. To identify the selection of keywords 170, words and phrases in the content 110 can be compared to words and phrases in the dictionary of specific words and phrases 140. Where individual ones of the words and phrases in the dictionary 140 are located within the content 110, those individual words and phrases can be added to a keyword list of potential keywords 160. Importantly, for each time an individual word or phrase in the dictionary 150 can be located in the content 110, a counter for the individual word can be incremented. Preferably, though, the counters can be weighted for different ones of the words and phrases in the dictionary 140 depending upon the subjective importance of the word or phrase.

To more ably manage the processing of the content 110, the keyword generation process 200 can reduce the content 110 to discrete chunks 130 in memory 120 in which the keyword generation process 200 can process each chunk 130 individually—whether concurrently in separate threads of execution, or separate processes, or sequentially in the same thread of execution or process. In any case, for each chunk 130, the keyword generation process 200 can locate all instances of the specific words and phrases in the dictionary 150.

Notably, each instance can be written to the keyword list, though subsequent instances only result in the incrementing of the respective counter. Furthermore, in a preferred aspect of the invention, each specific word or phrase in the dictionary 150 can include one or more words and phrases which are synonymous to the specific word or phrase. In this way, though a synonymous word or phrase may be located in the chunk 130, only the specific word or phrase can be added to the keyword list 160. Similarly, once the specific word or phrase has been added to the keyword list 160, when the keyword generation process 200 locates a synonymous word or phrase in the chunk 130, the counter for the corresponding specific word or phrase can be incremented.

Once a chunk 130 has been processed for the specific words and phrases in the dictionary 150, the chunk 130 can be inspected for words and phrases having font attributes which vary from the font attributes of the other words in the chunk 130. In this regard, the font attributes can include, but are not limited to font types, font sizes, bolding, underlining, italicization, font color, and the like. When encountering a word or phrase whose font attributes vary from the surrounding text, the entire word or phrase can be posted to a list of words or phrases to be added to the dictionary 150. Also, the encountered word or phrase can be added to the keyword list and a counter can be incremented accordingly.

Each chunk 130 in the content 110 can be processed as described herein. When no chunks remain to be processed, the keyword generation process 200 can inspect the counters for each word or phrase in the keyword list 160. A select number of words or phrases in the keyword list 160 having the highest counter values can be chosen as the keywords 170 for the content 110. Importantly, the skilled artisan will recognize the substantial and inherent advantages of the system illustrated in FIG. 1. Most notably, the foregoing system operates automatically and autonomously upon content 110 to produce the keywords 170. No manual intervention will be required. Also, the keyword generation process 200 can be self-configuring in that words and phrases can be added to the dictionary 150 when considered notable within the content 110 itself.

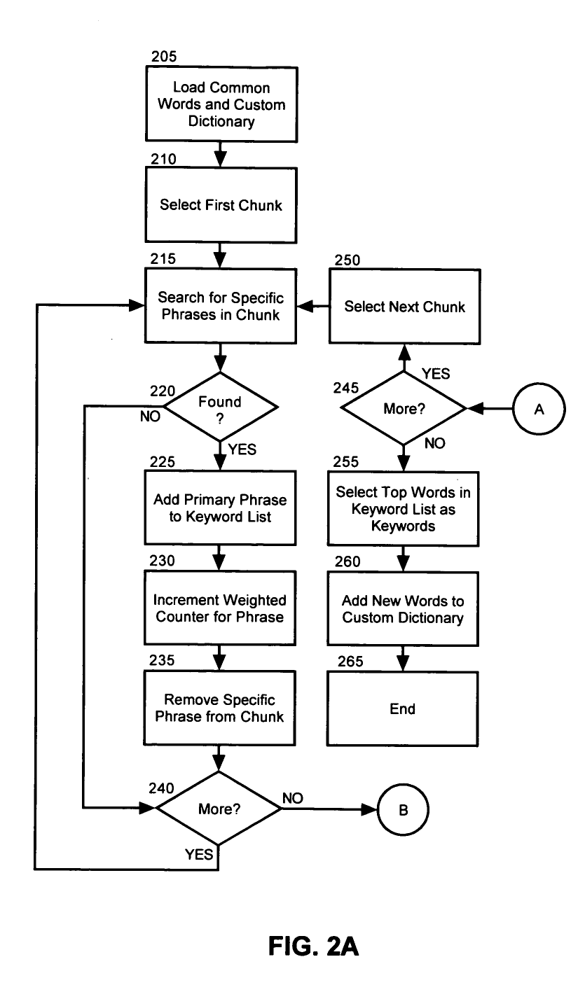

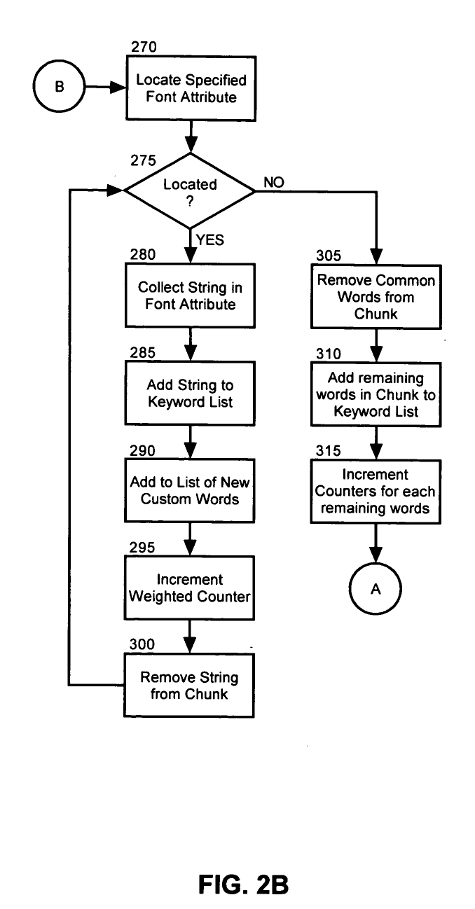

In more particularly illustration of the foregoing methodology, FIGS. 2A and 2B, taken together, are a flow chart illustrating a process for self-configuring keyword derivation for learning content. Beginning first in block 205 of FIG. 2A, a selection of common words can loaded into memory for convenient access as can a dictionary of words and phrases which are specific to a domain of interest. In block 210, a first chunk of content can be selected for processing. In blocks 215 through 240, the first chunk can be processed with respect to the dictionary of specific words and phrases in an attempt to locate all incidents in the chunk of all words and phrases in the dictionary.

More specifically, in block 215 the chunk can be searched for an occurrence of any one of the words and phrases in the dictionary. In decision block 220, if an occurrence is located in the chunk, in block 225 the primary version of the located occurrence can be added to a list of keywords under consideration. in further explanation, each entry in the dictionary of words and phrases which are specific to a particular domain optionally can include one or more synonymous variants. The chunk can be searched for an occurrence of any one of the words or phrases in the dictionary along with any one of the existing variants. In the event that a variant is located in the chunk, however, the keyword generation process will treat the location as if the primary word or phrase corresponding to the variant has been located.

Notably, the located word or phrase is to be added to the keyword list only in response to the first time the word or phrase, or any one of its variants, has been located in the content. Subsequently, the location of the word or phrase will be recorded simply by incrementing an associated counter. In either case, then, in block 230 a counter can be incremented for the located word or phrase and in block 235, the located word or phrase can be removed from chunk so that the located word or phrase will not be doubly processed. In any event, in decision block 240, if more of the chunk is to be processed with respect to the dictionary, the method can continue to decision block 240 until there are no more words or phrases in the dictionary to be located in the chunk. The process then can continue through jump circle B to the process of FIG. 2B.

Referring now to FIG. 2B, in block 270, the remaining words and phrases in the chunk can be analyzed to detect words having font attributes which differ from the font attributes of other words in the chunk. Specifically, by detecting a variation in the font attribute, it can be presumed that the author of the content intended upon emphasizing key terms in the content through the use of a different font attribute. Hence, in the present invention it is presumed that a variation of font attribute can indicate a likely candidate for the keyword list.

If in decision block 275, a variation in font attributes can be located in the chunk, in block 280 the entire string affected by the font attribute variation can be collected and in block 285 the string can be stored in the keyword list. In block 290 the string further can be added to the list of words to be added to the dictionary and in block 295 a counter for the string can be incremented. Finally, in block 300, the string can be removed from the chunk and the process can return to decision block 275. Notably, the process for identifying font attribute variations can continue for the entire remaining chunk in blocks 280 through 300. Namely, each time a variation is detected, the corresponding string can be collected and it can be determined whether the string already has been accounted for in the keyword list. If not, the string can be added to the keyword list. In either case, the counter can be incremented.

Once all of the chunk has been processed for font attribute variations, in block 305 all of the common words appearing in among the remaining words of the chunk can be removed. Subsequently, in block 310, each of the remaining words in the chunk can be processed for addition to the keyword list and in block 315 the respective counters for the words can be incremented. Specifically, each remaining word in the chunk can be added to the keyword list when first located in the chunk. For each subsequent appearance, the counter of the word can be incremented only. In any case, the process can return to FIG. 2A through jump circle A.

In decision block 245, if more chunks remain to be processed for the content, in block 250 the next chunk can be selected in the content and the process can begin anew for the newly selected chunk. When no more chunks remain to be processed in the content, however, in block 255 the top words in the keyword list can be selected as the keywords for the content. For instance, the words and phrases in the keyword list having the highest counter values can be selected since those words and phrases will represent words and phrases appearing the most within the content. In any case, once the keywords have been selected, in block 260 the words and phrases which had been selected for addition to the dictionary can be added to the dictionary. In this way, the self-configuring nature of the keyword generation process can evolve dynamically. Finally, the process can end in block 265.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A keyword generation system comprising:
a content parser configured to parse individual words and phrases in a selected portion of content;
a dictionary of words and phrases specific to a particular domain associated with said content;
a list of keyword candidates comprising a plurality of words and phrases specific to said particular domain;
a counter for each of said words and phrases in said list; and,
a keyword generation process both coupled to each of said content parser, dictionary, said list, and said counter and also programmed to identify said words and phrases specific to said particular domain in said selected portion of content, to write said identified words and phrases to said list of keyword candidates, to increment said counter for each of said words and phrases in said list each time said keyword generation process locates each of said words and phrases in said selected portion of content, and to select one or more of said words and phrases in said list as keywords for said content based upon said counter for each of said words and phrases in said list.

2. The system of claim 1, further comprising a list of common words coupled to said keyword generation process.

3. A keyword generation method comprising the steps of:
locating words and phrases in a selected portion of content, said words and phrases being specific to a particular domain;
adding a single instance of each of said located words and phrases to a list of keyword candidates;
for each located word and phrase which already had been added to said list of keyword candidates, incrementing a counter associated with said located word and phrase; and,
selecting keywords from said list of keyword candidates based upon words and phrases in said list having a highest counter value.

4. The method of claim 3, further comprising the step removing from consideration from said selected portion of content each of every word and phrase in said list of keyword candidates and words and phrases which are common in nature.

5. The method of claim 3, further comprising the steps of:
detecting a variation in font attributes in said selected portion of content;
selecting a string in said selected portion of content affected by said variation; and,
adding said string to said list of keyword candidates.

6. The method of claim 5, further comprising the step of subsequently identifying said string as a word and phrase which is specific to said particular domain.

7. The method of claim 3, further comprising the step of repeated performing the locating, adding and incrementing steps for selected chunks of said selected portion of content until no content remains to be processed.

8. A machine readable storage having stored thereon a computer program for keyword generation, the computer program comprising a routine set of instructions which when executed by the machine cause the machine to perform the steps of:
locating words and phrases in a selected portion of content, said words and phrases being specific to a particular domain;
adding a single instance of each of said located words and phrases to a list of keyword candidates;
for each located word and phrase which already had been added to said list of keyword candidates, incrementing a counter associated with said located word and phrase; and,
selecting keywords from said list of keyword candidates based upon words and phrases in said list having a highest counter value.

9. The machine readable storage of claim 8, further comprising the step removing from consideration from said selected portion of content each of every word and phrase in said list of keyword candidates and words and phrases which are common in nature.

10. The machine readable storage of claim 8, further comprising the steps of:
detecting a variation in font attributes in said selected portion of content;
selecting a string in said selected portion of content affected by said variation;
adding said string to said list of keyword candidates.

11. The machine readable storage of claim 10, further comprising the step of subsequently identifying said string as a word and phrase which is specific to said particular domain.

12. The machine readable storage of claim 8, further comprising the step of repeated performing the locating, adding and incrementing steps for selected chunks of said selected portion of content until no content remains to be processed.
